(19) United States
(12) Patent Application Publication
(10) Pub. No.: US 2015/0268170 A1
(43) Pub. Date: Sep. 24, 2015

(54) ENERGY EMISSION EVENT DETECTION

(71) Applicants: Miles L. Scott, Rohnert Park, CA (US); Alan Shulman, Santa Rosa, CA (US); Donald Robert Snyder, III, Crestview, FL (US); Sean Sullivan, Santa Rosa, CA (US)

(72) Inventors: Miles L. Scott, Rohnert Park, CA (US); Alan Shulman, Santa Rosa, CA (US); Donald Robert Snyder, III, Crestview, FL (US); Sean Sullivan, Santa Rosa, CA (US)

(73) Assignee: Doubleshot, Inc., Rohnert Park, CA (US)

(21) Appl. No.: 14/732,149

(22) Filed: Jun. 5, 2015

Related U.S. Application Data
(62) Division of application No. 12/267,455, filed on Nov. 7, 2008.
(60) Provisional application No. 60/986,586, filed on Nov. 8, 2007.

(51) Int. Cl. G01N 21/75; G01J 1/02

(52) U.S. Cl. CPC G01N 21/75; G01J 1/02; G01N 2201/12

(57) ABSTRACT

Methods and systems for detecting an energy emission event are provided. In a method for detecting an energy emission event, a reference event signal is compared with a received event signal. In some embodiments, the reference event signal is associated with radiated energy having a predetermined temporal response. A detection signal is output when the received event signal corresponds to the reference event signal. In response to outputting the detection signal, imagery of a location in proximity to where the received event signal originated is captured or processed. Using the captured imagery and the detection signal, a determination of where the received event signal originated is made.

### CROSS-REFERENCE TO RELATED APPLICATIONS

The present application claims the benefit of priority of U.S. Provisional Application No. 60/986,586 filed Nov. 8, 2007, entitled “Low Cost Gunshot Detection System,” the disclosure of which is expressly incorporated herein by reference in its entirety.

### BACKGROUND

1. Technical Field

Embodiments consistent with the presently-claimed invention relate to systems adapted to detect energy emission events and to methods for detecting and locating the origin of explosive reactions within a geographic region.

2. Discussion of Related Art

Systems for detecting and locating the origin of energy emission events have been used in a broad range of applications, including chemical processing, gunshot detection, and other law enforcement applications. These systems may use any one of a number of detection techniques. Some techniques, for example, use sensors to detect the pressure resulting from an explosive reaction or to detect the pressure generated by the movement of a projectile through the air. Other techniques may include acoustic detection systems that utilize a distributed network of sensors to measure the characteristics of sound waves radiating outward from an explosive reaction, such as a gunshot.

Acoustic detection systems are commonly used by law enforcement to detect, locate, and alert law enforcement to incidents of gunshots. Some acoustic detection systems use a series of acoustic sensors placed throughout a protected area to determine the location of the gunshot. Using a technique called acoustic triangulation, the differences in the arrival times of sound waves measured at three different acoustic sensors are used to calculate the origination of a gunshot.

The effectiveness and the accuracy of acoustic detection systems, however, can be limited by a number of factors. For example, the ability to accurately detect a gunshot may be dependent on the number and the spatial arrangement of acoustic sensors in a given area. Sensors placed too close together may not be able to distinguish a gunshot from a ball bouncing or a car backfiring. If the sensors are placed too far apart, no three sensors may be close enough to one another to perform acoustic triangulation. Further, in urban environments, high rise buildings and other structures may reflect the radiating sound waves before the waves reach an acoustic sensor, creating a delayed measurement. In some cases, the delayed measurement may result in a missed or inaccurate gunshot detection and/or location identification. Finally, although many acoustic detection systems can locate the origin of the explosion or gunshot, many of these systems fail to identify the particular source that created the detected event. In other words, many acoustic detection systems lack the ability to provide imagery of the location and the source where the gunshot or explosion was detected coincident with detecting the event.

### SUMMARY

Methods for detecting an energy emission event are provided. In a method for detecting an energy emission event, a reference event signal is compared with a received event signal. In some embodiments, the reference event signal is associated with radiated energy having a predetermined temporal response. A detection signal is output when the received event signal corresponds to the reference event signal. In response to outputting the detection signal, imagery of a location in proximity to where the received event signal originated is captured or processed. Using the captured imagery and the detection signal, a determination of where the received event signal originated is made.

It is to be understood that both the foregoing general description and the following detailed description are exemplary and explanatory only and are not restrictive of the invention. Further embodiments and aspects of the presently-claimed invention are described with reference to the accompanying drawings, which are incorporated in and constitute a part of this specification.

### BRIEF DESCRIPTION OF THE DRAWINGS

FIG. 1 shows a block diagram illustrating an exemplary system for detecting an energy emission event.

FIG. 2 shows a block diagram of an exemplary sensor.

FIG. 3 shows a block diagram of an exemplary sensor pixel array.

FIG. 4 shows a block diagram of an exemplary sensor array.

FIG. 5 shows an exemplary reference event signal.

FIG. 6 shows a flowchart illustrating steps in an exemplary method for detecting an energy emission event.

FIG. 7 shows a flowchart illustrating steps in an additional exemplary method for detecting an energy emission event.

### DETAILED DESCRIPTION

Reference will now be made in detail to the embodiments, examples of which are illustrated in the accompanying drawings. Wherever possible, the same reference numbers will be used throughout the drawings to refer to the same or like parts.

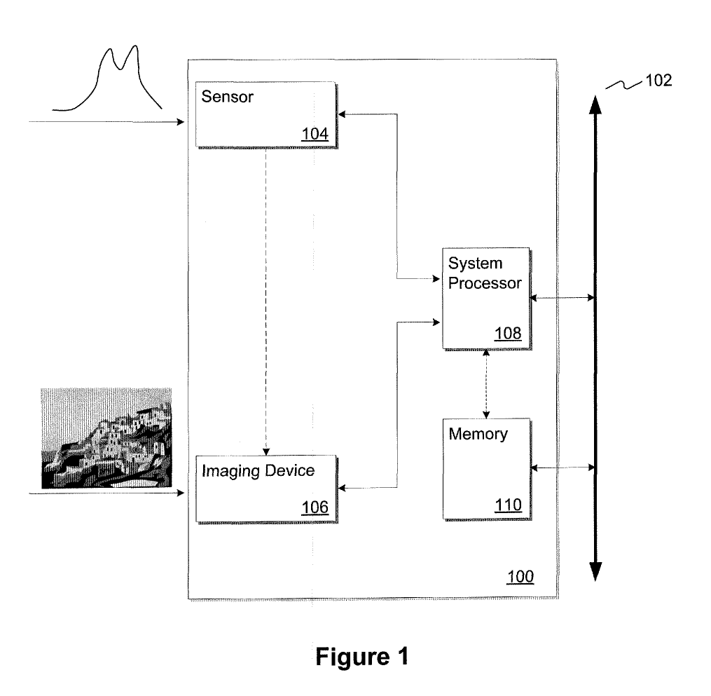

FIG. 1 shows a block diagram illustrating components in system 100 for detecting and/or locating energy emission events. As shown in FIG. 1, system 100 may include, among other features, sensor 104, imaging device 106, and memory 110 coupled to exchange data and commands with system processor 108. Exemplary system 100 may also be able to access other devices or functional modules (not shown) coupled to bus 102, such as a wireless receiver, a secondary memory, a processor, or a peripheral device to store or further process data generated from or used by system 100. Bus 102 may include an optical, electrical, or wireless communication channel configured to transfer data between sensor 104, imaging device 106, and system processor 108. In some embodiments, data may include imagery or a reference event signal from an external source (not shown).

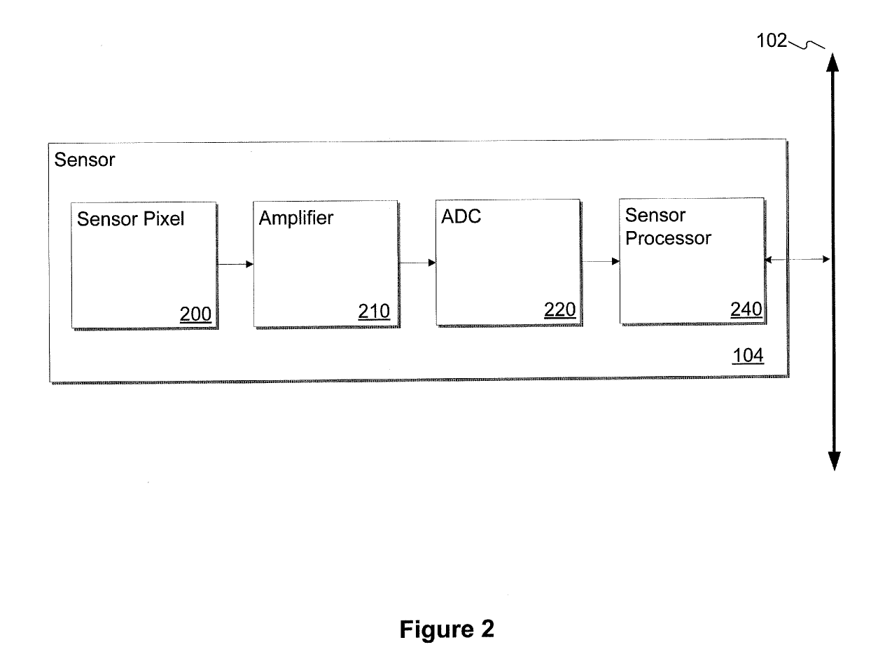

As shown in FIG. 1, exemplary system 100 may include sensor 104, a sensing device capable of detecting energy radiating from an energy emission event. In some embodiments, sensor 104 may be adapted to detect energy radiating within a predetermined range of wavelengths. For example, sensor 104 may include a detector, such as a quantum detector, adapted to detect electromagnetic radiation. Electromagnetic radiation may include, for example, wavelengths in the visible, short-wave infrared or mid-wave infrared spectrums. Sensor 104 may be a singe pixel, multiple pixels, a linear array, or a two-dimensional array with a low pixel count as compared to imaging sensor 106. In some embodiments, exemplary sensor 104 may also include one or more additional components, such as an amplifier, an analog to digital converter (ADC), and/or a processor, as illustrated in FIG. 2. Sensor 104 generates data associated with a detected event in a format capable of being processed by system processor 108. For example, data output from sensor 104 may be digitized or coded in a particular format based on factors, such as the architecture of system processor 108, the bandwidth of the connection coupling sensor 104 to system processor 108, or other electrical or mechanical constraints of system 100. Alternatively or additionally, output of sensor 104 may be provided directly to imaging device 106, bypassing system processor 108. In some embodiments, system 100 may include a plurality of sensors (not shown) having the same, similar, or different capabilities than sensor 104. These additional sensors may also be coupled to communicate with each other or with system processor 108 in a similar manner as described for sensor 104.

Exemplary imaging device 106 is a device capable of acquiring data, such as imagery and sound, of a location associated with the origin of a detected energy emission event. The origin of the detected energy emission event may be a location or a location in proximity to the source of the detected energy emission. In some embodiments, imaging device 106 may be a sensor having a focal plane array with a high pixel count, such as one million pixels or more. The focal plane array may be comprised of charged-coupled devices (CCDs), complementary metal oxide semiconductor (CMOS) image sensors, or similar image sensing technologies.

Imaging device 106 may also be an instrumentation-grade digital video camera, or like device capable of receiving sequential image data, digitizing the image data, and outputting the image data to system processor 108 for processing. In some embodiments, imaging device 106 may be a device having a focal plane array comprised electron multiplying charged-coupled devices (EMCCDs) or a device comprised of a short-wave or a mid-wave infrared focal plane. In some embodiments, imaging device 106 may be configured to acquire images at frame rates of five times greater than the signal duration. In other embodiments, imaging device 106 may be configured to acquire images at frame rates at video or near video frequency, or as required for detection of the energy emission event.

In some embodiments, imaging device 106 may be coupled to receive commands or data from system processor 108. For example, imaging device 106 may receive commands or settings from system processor 108 related to frame capture rate, aperture settings, or other common digital imaging device controls. Alternatively or additionally, imaging device 106 may be coupled to receive commands from sensor 104. For example, imaging device 106 may receive commands from sensor 104 to control image capture or transmission based on a detected energy emission event. In other cases, sensor 104 may provide operational or status information of sensor 104 to imaging device 106 to improve power management or to reduce processing demands of system 100. In some embodiments, imaging device 106 may be combined with sensor 104. In other embodiments, sensor 104 and imaging device 106 may be located remotely from other components of system 100. Located remotely, sensor 104 and imaging device 106 may include a wireless transceiver (not shown) to communicate with system 100 using a peripheral interface (not shown) coupled to bus 102 capable of communicating with the wireless transceiver.

Exemplary memory 110 may be one or more memory devices that store data as well as software, firmware, assembly, or micro code. Stored data may include, but is not limited to, data received from sensor 104, reference event signals used to process the data received from sensor 104, and data associated with a detected energy emission event received by imaging device 106. Memory 110 may include one or more of volatile or non volatile semiconductor memories, magnetic storage, or optical storage. In some embodiments, memory 110 may be a portable computer-readable storage medium, such as a portable memory card, including, for example Compact Flash cards (CF cards), Secure Digital cards (SD cards), Multi-Media cards (MMC cards), or Memory Stick cards (MS cards). Portable memory devices may include those equipped with a connector plug such as, a Universal Serial Bus (USB) connector or a FireWire® connector for uploading or downloading data and/or media between memory 110 and external computing devices (not shown) coupled to communicate with system 100.

Exemplary system processor 108 may be a general purpose processor, application specific integrated circuit (ASIC), embedded processor, field programmable gate array (FPGA), microcontroller, or other like device. System processor 108 may act upon instructions and data to process data output from sensor 104 and imaging device 106. That is, system processor 108 may exchange commands, data, and status information with sensor 104 and imaging device 106 to detect and to locate the source and the origin of an energy emission event. For example, system processor 108 may execute code to time correlate a detected energy emission event from sensor 104 with data from imaging device 106, such as imagery and sound received from imaging device 106 or data associated with a sensor or a sensor array. In some embodiments, system processor 108 may be coupled to exchange data or commands with memory 110. For example, system processor 108 may contain code operable to perform frame capture on captured sequential data, such as video data. In other embodiments, system processor 108 can exchange data, including control information and instructions with other devices or functional modules coupled to system 100 using bus 102.

FIG. 2 shows a block diagram of an exemplary sensor 104. As shown in FIG. 2, sensor 104 may include a detector, such as sensor pixel 200 or sensor pixel array 300, whose output is coupled through amplifier 210 to analog to digital converter (ADC) 220, and sensor processor 240. Sensor pixel 200 may be a device, such as a quantum detector, adapted to detect energy emissions in the infrared or other spectrum. For example, sensor pixel 200 may be a photodiode, photoconductor, or microvolometer detector composed of lead selenide (PbSe), lead sulfide (PbS), indium antimonide (InSb), or mercury cadmium telluride (HgCdTe). In some embodiments, other detector materials may be used that provide a similar spectral response and response time as the previously listed materials. For example, sensor pixel 200 may be adapted to detect radiation in a range of 1-5 μm, with a peak sensitivity from 2-5 μm based on the underlying detector material. Sensor pixel 200 may be a single pixel detector with a pre-defined active area. For example, in some embodiments, sensor pixel 200 may have an active area ranging from 0.5-5 mm². In some embodiments, sensor pixel 200 may be adapted to have a narrow field of view, which determines the angular extent of the observable visual field of sensor pixel 200. For example, in some embodiments, sensor pixel 200 may have a 10 degree×80 degree field of view. That is, sensor pixel 200 can detect energy emissions within a specified range of wavelengths within a 10 degree horizontal field of view and an 80 degree vertical field of view. Sensor pixel 200 may be adapted to generate a voltage in response to receiving energy emissions within a pre-determined spectral response and within the previously discussed field of view. Here, the voltage generated may be proportional to the amount of received energy emission within the spectral response of sensor pixel 200.

Amplifier 210 may be a general purpose amplifier or a transimpedance amplifier adapted to amplify the voltage output from sensor pixel 200. In some embodiments, amplifier 210 may be alternating current (AC) coupled to the output of sensor pixel 200. In certain embodiments, amplifier 210 and sensor pixel 200 may be combined in a single device. The output of amplifier 210 may be coupled to ADC 220 to convert the analog output of amplifier 210 to digital values that may be received and processed by sensor processor 240. Sensor processor 240 may be a general purpose processor, application specific integrated circuit (ASIC), embedded processor, field programmable gate array (FPGA), microcontroller, or other like device capable of executing code to process digitized detector data received from ADC 220. For example, sensor processor 240 may execute code to compare a received event signal with a reference event signal to determine whether the received event signal is an energy emission event. In some embodiments, the reference event signal may be stored on sensor processor 240 or on computer-readable storage media accessible by sensor processor 240. Sensor processor 240 may then execute code to send a signal indicating a detected energy emission event to system processor 108 for additional processing.

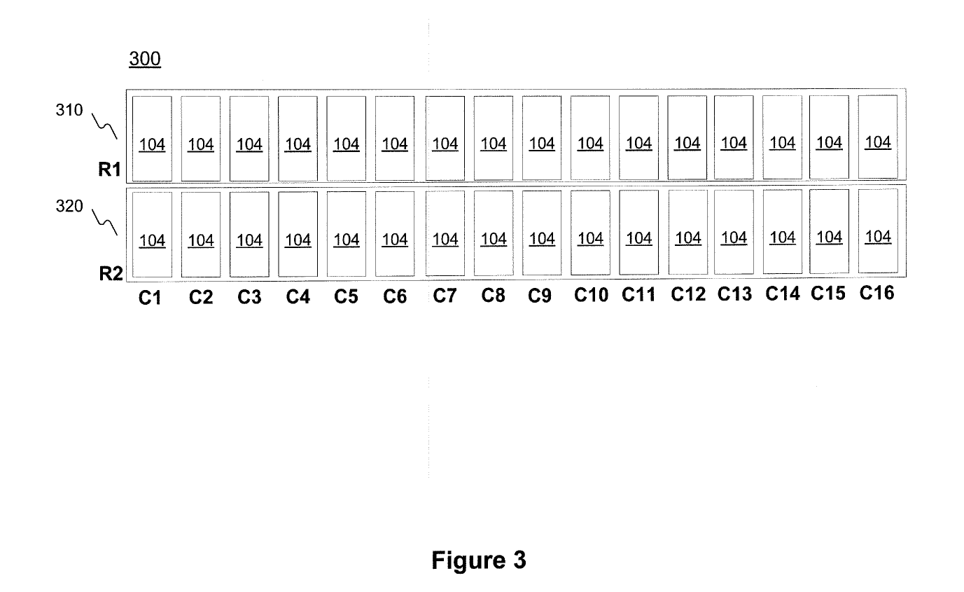

FIG. 3 shows a block diagram of exemplary sensor pixel array 300. As shown in FIG. 3 and previously discussed, sensor pixel array 300 may be an array of sensor pixels 200 arranged in a particular pattern adapted to detect an energy emission event. In some embodiments, each row may contain similar sensor pixels 200 having a common response time and spectral response. In other embodiments, sensor pixel array 300 may be an array of distinct sensor pixels 200 adapted to have different response times, spectral responses, or fields of view, based on a particular application. For example, in some applications sensor pixel array 300 may be adapted to detect energy emissions across multiple spectral ranges. Accordingly, sensor pixel array 300 may included several sensor pixels 200 with distinct spectral responses. For example, row R1 310 may include sensor pixels configured to detect energy emission events ranging from 1-3 um. In contrast, row R2 320 may include sensor pixels configured to detect energy emission events ranging from 2-6 um. Alternatively, sensor pixels having similar performance characteristics may also be aligned vertically within a column. For example, sensor pixels located in the same column, such as C1, may be configured to have the same or similar performance characteristics. In other embodiments using sensor pixel array 300, similar sensor pixels 200 may be arranged in other patterns suitable to provide sufficient energy emission detection for the particular application. In other applications, sensor pixel array 300 may be adapted to detect energy emission events having a distinct temporal response using sensor pixels 200 with varying response times. In these applications, sensor pixels 200 with different response times may be arranged in a similar manner as previously described.

In some embodiments, sensor pixels 200 may be logically coupled to operate as a quad detector. For example, sensor pixel 200 located in row R1 310 and column C1 may be coupled to sensor pixel 200 located in row R1 310 and column C2, row R2 320 and column C1, and row R2 320 and column C2. In other embodiments, a quad detector comprising more than four sensor pixels 200 may be similarly configured. Coupled to operate as a quad detector, sensor pixels 200 may detect the direction of incident radiation generated by an energy emission event based on the amount of radiation detected by each sensor within the quad detector.

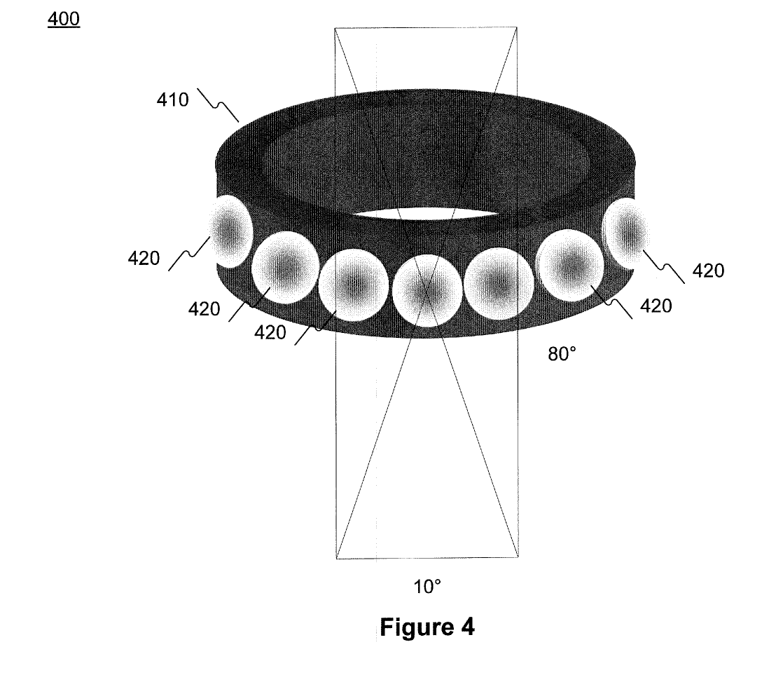

FIG. 4 shows a block diagram of exemplary sensor array 400. In some embodiments, sensor array 400 may include one or more series lenses 420 mounted on a structure to create a composite sensor with a wide field of view. For example, as shown in FIG. 4, one or more series lenses 420, each covering a pixel sensor or pixel sensor array, may be mounted on ring 410 to provide a 360 degree field of view. The number of series lenses and their configuration may vary depending on the field of view of the pixel sensor or pixel sensor array underneath each lens. For example, to achieve a horizontal field of view of 360 degrees, sensor array 400 may have thirty-six lenses, each lens covering a sensor pixel array 300 and having a horizontal field of view such that the combined thirty-six lenses have a field of view that is greater than or equal to 360 degrees.

Ring 410 may be composed of metal, plastic, or any other material sufficient to support multiple series lenses 420 and associated sensor pixels 200 or sensor pixel arrays 300. In some embodiments, system 100 may include multiple sensor arrays 400 placed in a location or on a vehicle to provide temporal and spatial detection of energy emission events surrounding the location or vehicle. For example, multiple sensor arrays 400 may be mounted on a law enforcement vehicle or aircraft, an unmanned aerial vehicle, or a robotically-controlled device. Each sensor array 400 may be configured to have a particular horizontal and/or vertical field of view, which when combined with each sensor array 400 provide a desired composite field of view as measured from the vehicle, the device, or the fixed location.

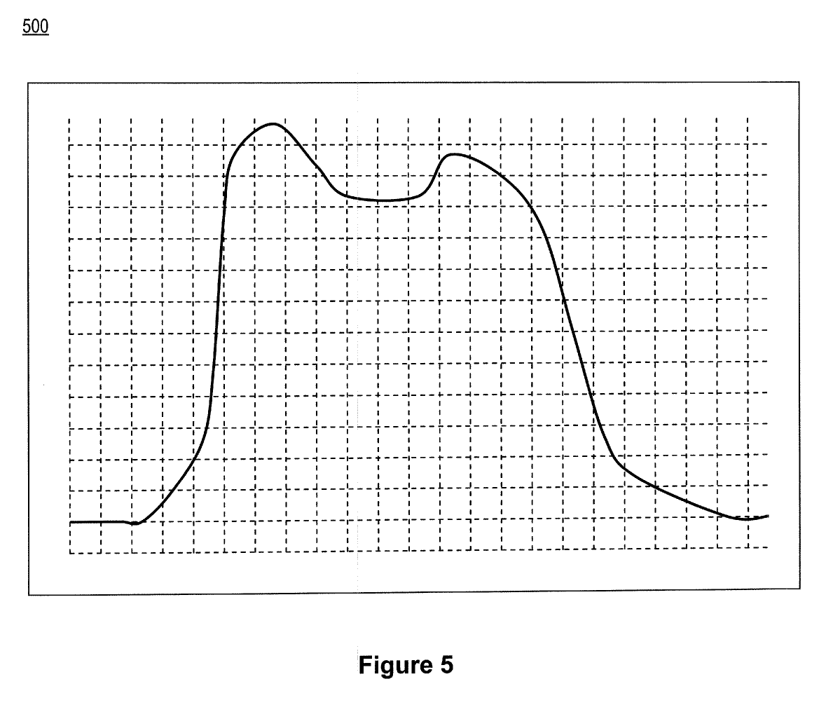

FIG. 5 shows an exemplary reference event signal 500. As shown in FIG. 5, reference event signal 500 may be a waveform having a pre-defined temporal and/or spectral signature associated with a particular energy emission event. Reference event signal 500 may be accessed by sensor processor 240 to determine whether or not radiated energy received by sensor 104 is an energy emission event based on a comparison with reference event signal 500. In some embodiments, the comparison may be based on parametric characteristics of reference event signal 500 and the received event signal. Parametric characteristics may include rise time and fall time or a range of rise times and fall times associated with reference event signal 500. For example, energy emitted from a strobe light may have rise time ranging from 800 ns to 1 ms with a fall time ranging from 2 ms to 2.8 ms. Alternatively or additionally, other parametric characteristics may be associated with reference event signal 500 and considered for purposes of comparison. Other temporal characteristics may include, but are not limited to, pulse width, amplitude, frequency, period, the number of peaks, or a ratio of peaks. Reference event signal 500 may include one or more distinct reference waveforms corresponding to one or more distinct energy emission signatures. In some embodiments, reference event signal 500 may be modified, added, or deleted through a peripheral interface (not shown) coupled to bus 102.

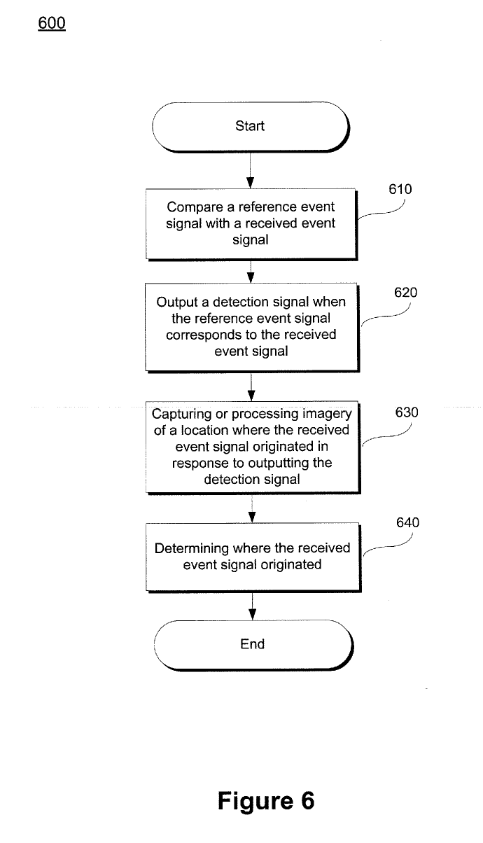

FIG. 6 shows a flowchart illustrating steps in an exemplary method for detecting an energy emission event. It will be readily appreciated by one having ordinary skill in the art that the illustrated procedure can be altered to delete steps, move steps, or further include additional steps.

In step 610, a reference event signal is compared with a received event signal. For example, the comparison may operate on parametric characteristics of the received event signal and the reference event signal, such as rise time and fall time. Alternatively or additionally, the comparison may utilize image processing techniques. In some embodiments, the reference event signal may have pre-defined temporal or spectral characteristics corresponding to a particular type of radiated energy. For example, in certain embodiments, the reference event signal may be similar to the waveform illustrated in FIG. 5. In some embodiments, the comparison may be performed by a general purpose processor or other computing device or devices, such as sensor processor 240 as shown in FIG. 2. The reference event signal may be stored in a computer-readable storage memory, such as memory 110, and accessed by sensor processor 240 for comparison with a received event signal. In some embodiments, the received event signal may be detected by a sensor adapted to detect radiated energy in one or more spectrums, such as infrared energy. For example, in some embodiments, sensor 104 may be used to detect a particular spectrum of radiated energy based on the particular application. In other embodiments, sensor 104 may be adapted to detect broadband electromagnetic energy. In some cases, the received event signal may be produced by a chemical explosion related to chemical processing or manufacturing. In other cases, the received event signal may be produced by an explosive device or an illumination device, such as fireworks or an emergency strobe, respectively.

In step 620, a detection signal is output when the received event signal corresponds to the reference event signal. The determination as to whether the received event signal corresponds to the reference event signal may be based on, for example, a graphical comparison of the waveforms, or on certain temporal characteristics, such as rise time and fall time. Other temporal characteristics may include, but are not limited to, pulse width, amplitude, frequency, period, the number of peaks, or a ratio of peaks. The type of comparison used may be based on any one of several factors, such as, for example, the computational capabilities of the processing device, the desired comparison accuracy of the system, and the processing time budget allocated to performing the comparison. In some embodiments, a detection signal may be an analog output or a digital output capable of being processed by a general purpose computing device, such as system processor 108 as shown in FIG. 1.

The detection signal may include a time stamp or other temporal meta-data corresponding to when the received event signal was detected. For example, the time stamp may be added by sensor processor 240. In other embodiments, the time stamp may be added by system processor 108 upon receipt of the detection signal.

In step 630, imagery or data of a location in proximity to the origin of the received event signal is captured or processed in response to the generation of the detection signal. In some embodiments, the imagery may be a still image or moving images, such as those captured by a digital video camera or like imaging device. In some embodiments, still image may be captured in response to the generation of the detection event. In other embodiments, imagery may be captured continuously at periodic rates and processed in response to the generation of the detection signal. Processing may include executing code to perform frame capture from a video stream. Imagery may be captured using imaging device 106, at frame rates of five times the duration of the received event signal. In other embodiments, imagery may be captured using other frame rates sufficient to provide adequate temporal resolution based on the system requirements. In some embodiments, the captured imagery may be time stamped to facilitate time correlating the imagery with the detected energy emission event. For example, the imagery may be time stamped by the imaging device using generally available techniques, such as those used in digital still and digital video cameras. Alternatively or additionally, the imagery may be time stamped by a computing device independent from the imaging device, like system processor 108, as shown in FIG. 1. In some embodiments, the captured data may include sound or other non-visual data. Both imagery and data may be stored in a computer-readable storage medium coupled to communicate with a system processor, like memory 110, also shown in FIG. 1.

In step 640, a location corresponding to where the received event signal originated may be determined, based on the captured imagery and the event detection signal. That is, by comparing the time stamps associated with the event detection signal and the captured imagery, a location associated with the origin of the received event signal may be determined. For example, the detection signal and its associated time stamp may provide an indication of when a particular energy emission event was detected. Each detected signal and its associated time stamp may be stored in memory and/or processed directly by a processor. An imaging device coupled to the processor may continuously capture imagery, such as imagery and sound, at a fixed or a variable rate. In some embodiments, the imaging device may be configured to acquire imagery at video or near video rate or frequency, which can be, but is not limited to, a range 2 to 30 frames per second. Captured imagery may also be time stamped and stored and/or processed directly by a processor. In some embodiments, the time stamp associated with the detected energy emission event and the time stamp associated with imagery or data captured from the imaging device may be based on a common clock source, such as a GPS signal, or based on multiple synchronized clock sources. The time stamp associated with a detected energy emission event may then be compared with the time stamps associate the imagery or data captured by the imaging device. Captured imagery or data having the same time stamp or a range of time stamps occurring before and/or after the time stamp of the detected energy emission event may provide data, such as image data and/or sound, about the origin of the received event signal that produced the detection signal. For example, using the image containing the origin of the received event signal, the location of any point within the image may be calculated by a processor using the location of the imaging device as a reference to determine the azimuth and elevation associated with origin of the event.

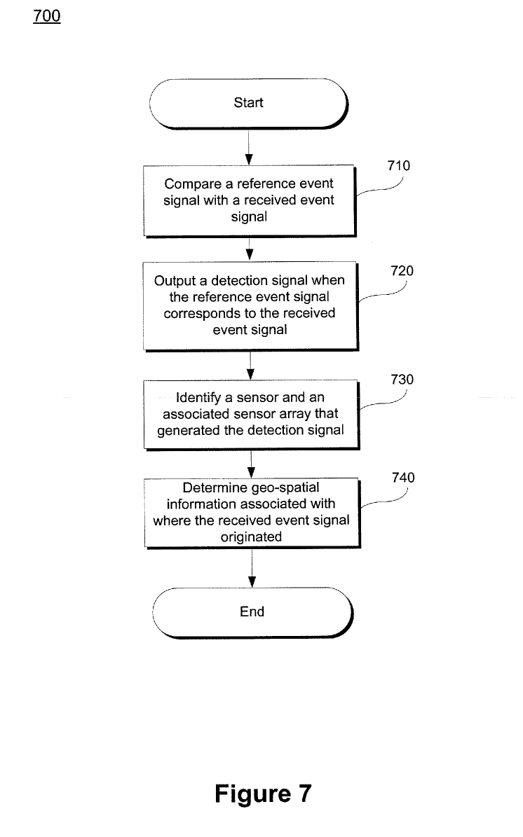

FIG. 7 shows a flowchart illustrating steps in an additional exemplary method for detecting an energy emission event. It will be readily appreciated by one having ordinary skill in the art that the illustrated procedure can be altered to delete steps, move steps, or further include additional steps. Steps 710 and 720 include elements similar to those described in steps 610 and 620, respectively.

In step 730, a sensor in an associated sensor array that generated the detection signal are identified to provide an indicator of temporal and spatial detection of an energy emission event. For example, each sensor pixel 200 may have a fast high temporal resolution with a comparatively lower spatial resolution as compared imaging device 106. In contrast, imaging device 106 may have a high spatial resolution and a comparatively lower temporal resolution as compared to sensor pixel 200. In other words, methods using a combination of sensor pixels 200 and imaging device 106 may be used to detect when and where an energy emission event occurred with high temporal and spatial accuracy.

In some embodiments, each sensor and each sensor array may be identified or addressable. For example, in some embodiments, a system may include three independently addressable sensor arrays operating together to provide a wide field of view for spatial detection of energy emission events. Each sensor array may include a plurality of sensor pixels or a plurality of sensor pixel arrays. In some embodiments, each sensor pixel array may be organized in rows and columns, as shown FIG. 3. In this case, each sensor pixel within a particular sensor pixel array may be identified by a row number and a column number. For example, a sensor pixel may be addressable as sensor array 1, sensor pixel 2-5. Here, the address may correspond to the sensor pixel located in row 2, column 5 on sensor array 1. Accordingly, by using the row number and column number a particular sensor pixel that detected the energy emission event may be identified. The resulting detection signal may then be tagged with the sensor array location information and time stamped as previously described in step 630 to provide temporal detection information associated with the detected energy emission event.

In step 740, geo-spatial information associated with origin of the received event signal may be determined based in part on the sensor array associated with the sensor that detected the energy emission event. As previously discussed, in some embodiments, a plurality of sensor arrays may be assigned or located at different pre-determined locations. Each sensor array may have a distinct field of view based on its location. Combined, the plurality of sensor arrays may provide a wide field of view to perform spatial detection of energy emission events. In operation, the identification of which one of a plurality of sensor arrays is associated with the sensor that generated the detection signal defines the field of view that includes the origin of the received event signal. In some embodiments, the field of view may be transformed into geo-spatial information based in part on the location of the sensor array and the physical boundaries defined by the field of view of the sensor array. For example, the location of the sensor array combined with the field of view of the detecting sensor may be used as a reference to approximate the azimuth and elevation associated with the origin of the received event signal.

Other embodiments of the present invention will be apparent to those skilled in the art from consideration of the specification and practice of one or more embodiments of the invention disclosed herein. It is intended that the specification and examples be considered as exemplary only, with a true scope and spirit of the invention being indicated by the following claims.

1.-33. (canceled)

34. A method of detecting an energy emission event, comprising:
detecting a received event signal using a detector with a wide field of view, the detector comprising a sensor array, the sensor array including sensors with overlapping fields of view;
comparing a reference event signal with the received event signal, wherein the reference event signal is associated with radiated energy having a predetermined temporal response;
outputting a detection signal when the received event signal corresponds to the reference event signal;
determining a first energy emission parameter and a second energy emission parameter; and
determining the direction of the energy emission event relative to the detector based on the first energy emission parameter and the second energy emission parameter.

35. The method of claim 34, wherein the radiated energy comprises electromagnetic energy.

36. The method of claim 34, wherein the predetermined temporal response comprises at least one of a rise time, a fall time, a pulse width, an amplitude, a number of peaks, or a ratio of peaks.

37. The method of claim 34, wherein comparing the reference event signal with the received event signal comprises analyzing parametric data.

38. The method of claim 34, further comprising determining the origin of the received event signal, comprising capturing an image of a location proximate to the origin of the received event signal following detection of the received event signal.

39. The method of claim 38, wherein the image of the location includes the energy emission event.

40. The method of claim 38, wherein determining the origin of the received event signal further comprises identifying geo-spatial information associated with a portion of the image in proximity to an origin of the received event signal.

41. The method of claim 40, wherein geo-spatial information comprises an elevation and azimuth, a latitude and longitude, or a street address.

42. The method of claim 34, further comprising determining temporal information associated with the received event signal.

43. The method of claim 34, wherein the radiated energy comprises a reflection and the calculated position is the position of the reflection surface.

44. The method of claim 34, further comprising determining the geographic origin of the received event signal based on the location of the detector, the direction of the energy emission event relative to the detector, and the reference signal.

45. The method of claim 34, wherein the wide field of view is substantially 360 degrees.

46. A non-transitory computer-readable storage medium storing instructions that, when executed by at least one processor, cause a system to perform steps comprising:
detecting a received event signal using a detector with a wide field of view, the detector comprising a sensor array, the sensor array including sensors with overlapping fields of view;
comparing a reference event signal with the received event signal, wherein the reference event signal is associated with radiated energy having a predetermined temporal response;
outputting a detection signal when the received event signal corresponds to the reference event signal;
determining a first energy emission parameter and a second energy emission parameter; and
determining the direction of the energy emission event relative to the detector based on the first energy emission parameter and the second energy emission parameter.

47. The computer-readable storage medium of claim 46, wherein the radiated energy comprises electromagnetic energy.

48. The computer-readable storage medium of claim 46, wherein the predetermined temporal response comprises at least one of a rise time, a fall time, a pulse width, an amplitude, a number of peaks, or a ratio of peaks.

49. The computer-readable storage medium of claim 46, wherein comparing the reference event signal with the received event signal comprises analyzing parametric data.

50. The computer-readable storage medium of claim 46, the steps further comprising determining the origin of the received event signal, comprising capturing an image of a location proximate to the origin of the received event signal following detection of the received event signal.

51. The method of claim 50, wherein the image of the location includes the energy emission event.

52. The method of claim 50, wherein determining the origin of the received event signal further comprises identifying geo-spatial information associated with a portion of the image in proximity to an origin of the received event signal.

53. The computer-readable storage medium of claim 52, wherein geo-spatial information comprises an elevation and azimuth, a latitude and longitude, or a street address.

54. The computer-readable storage medium of claim 46, further comprising determining temporal information associated with the received event signal.

55. The computer-readable storage medium of claim 46, wherein the radiated energy comprises a reflection and the calculated position is the position of the reflection surface.

56. The computer-readable storage medium of claim 46, further comprising the step of determining the geographic origin of the received event signal based on the location of the detector, the direction of the energy emission event relative to the detector, and the reference signal.

57. The computer-readable storage medium of claim 46, wherein the wide field of view is substantially 360 degrees.

58. A system comprising:
at least one processor; and
a non-transitory computer-readable storage medium storing instructions that, when executed by the at least one processor, cause the system to perform steps comprising:
detecting a received event signal using a detector with a wide field of view, the detector comprising a sensor array, the sensor array including sensors with overlapping fields of view;
comparing a reference event signal with the received event signal, wherein the reference event signal is associated with radiated energy having a predetermined temporal response;
outputting a detection signal when the received event signal corresponds to the reference event signal;
determining a first energy emission parameter and a second energy emission parameter; and
determining the direction of the energy emission event relative to the detector based on the first energy emission parameter and the second energy emission parameter.
